(19) United States
(12) Patent Application Publication
(10) Pub. No.: US 2012/0054655 A1
(43) Pub. Date: Mar. 1, 2012

(54) MOBILE DEVICE AND METHOD FOR OFFERING GRAPHIC USER INTERFACE

(75) Inventors: Ji Young KANG, Gyeonggi-do (KR); Il Geun BOK, Seoul (KR)

(73) Assignee: SAMSUNG ELECTRONICS CO., LTD., Gyeonggi-Do (KR)

(21) Appl. No.: 13/217,940

(22) Filed: Aug. 25, 2011

(30) Foreign Application Priority Data
Aug. 26, 2010 (KR) 10-2010-0082755

(51) Int. Cl. G06F 3/048

(52) U.S. Cl. 715/767; 715/780

(57) ABSTRACT

Provided are a mobile device and method for operating a graphic user interface (GUI) in connection with a specific screen of a media-related application. In the method for operating the GUI, the mobile device displays a GUI screen containing a media region and a text region. The media region is provided for at least one medium disposed therein. When text is inputted in the text region, the mobile device correlates the text with one of the at least one medium. Additionally, when there is a touch on the media region, the mobile device modifies the GUI of the touched media. This method allows a user to conveniently write a message to which at least one media is attached. In case where a plurality of media are attached to a message a check of the media selected as an attachment and the associated text can easily be made.

### CLAIM OF PRIORITY

This application claims, pursuant to 35 USC 119, priority to, and the benefit of the earlier filing date of, that patent application entitled “MOBILE DEVICE AND METHOD FOR OFFERING GRAPHIC USER INTERFACE,” filed in the Korean Intellectual Property Office on Aug. 26, 2010 and assigned Serial No. 10-2010-0082755, the contents of which are incorporated herein by reference.

### BACKGROUND OF THE INVENTION

1. Field of the Invention

The present invention relates generally to a mobile device and more particularly to a method for offering a GUI (Graphic User Interface) in connection with a specific screen of a media-related application.

2. Description of the Related Art

With remarkable growth of related technologies, a great variety of mobile devices have become increasingly popularized. Mobile devices not only provide their basic function of a voice call service, but also offer several data transmission services and various additional services. Thus, today's mobile devices have evolved into multimedia communication devices.

Recently, a number of media-related applications such as a multimedia message service (MMS) that allows the transmission of messages including multimedia contents such as images, audios, videos, etc. have been widely used. In order to keep pace with the popular use of these applications, GUIs relevant to specific screens of applications have been continuously developed in order to enhance the user's convenience.

However, as the screens develop changes in the newer screen versions may alter the position of functions or tasks that the user has become familiar with in a prior screen version.

### BRIEF SUMMARY OF THE INVENTION

Accordingly, the present invention is to address the above-mentioned problems and/or disadvantages and to offer at least the advantages described below.

An aspect of the present invention is to provide a GUI relevant to a specific screen of a media-related application in order to enhance the user's convenience.

Another aspect of the present invention is to provide a mobile device for realizing the above GUI.

According to one aspect of the present invention, provided is a method for offering a graphic user interface (GUI) of a mobile device, the method comprising: displaying a GUI screen containing a media region and a text region, the media region being provided for at least one media; when text is inputted in the text region, correlating the text with one of the at least one media; and when there is a touch on the media region, modifying the GUI of the at least one media.

According to another aspect of the present invention, provided is a mobile device comprising: a touch sensor unit configured to detect a user's touch input; a display unit configured to display a media region in which at least one media is disposed, and to display a text region in which text is inputted; and a control unit configured to control the display unit to dispose and focus the at least one media in the media region in response to a user's media selection received from the touch sensor unit, to control the display unit to display the text in the text region in response to a user's text input received from the touch sensor unit, to correlate the text with the focused media, and to control the display unit to focus another media in response to a touch input received from the touch sensor unit on the another media in the media region.

Aspects of this invention may allow a user to conveniently write a message to which at least one medium is attached. Particularly, in case where a user attaches plural media to the message, this invention may allow easily checking which medium is selected as the attachment file and what text is inputted into each medium.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating the configuration of a mobile device in accordance with an exemplary embodiment of the present invention.

FIG. 2 is a flow diagram illustrating a method for offering a GUI of the mobile device in accordance with an exemplary embodiment of the present invention.

FIG. 3 shows a series of screenshots of a mobile device GUI offered by a method in accordance with an exemplary embodiment of the present invention.

FIG. 4 shows screenshots of a mobile device GUI offered by a method in accordance with another exemplary embodiment of the present invention.

FIG. 5 shows screenshots illustrating a function to remove a medium in a message writing screen of a mobile device.

FIG. 6 shows screenshots illustrating a function to replace a medium in a message writing screen of a mobile device.

FIG. 7 shows screenshots illustrating a function to remove a combination of plural media in a message writing screen of a mobile device.

### DETAILED DESCRIPTION OF THE INVENTION

Exemplary, non-limiting, embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will convey the scope of the invention to those skilled in the art. The principles and features of this invention may be employed in various and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Although a mobile device will be exemplarily described herein, the present invention is not always limited to the mobile device. Alternatively, this invention may be applied to any other electronic devices that have a touch screen. The mobile device according to embodiments of this invention may include a mobile communication terminal, a portable multimedia player (PMP), a personal digital assistant (PDA), a smart phone, an MP3 player, and the like. Particularly, this invention may be applied to relatively larger mobile devices having a display more than 7 inches as well as smaller mobile devices having a display less than 4 inches; all of which being referred-to as a mobile device.

Among terms set forth herein, ‘a medium’ is used to mean any content including an image such as a picture or photo, a video, an audio, and the like, or any information, inputted or made by a user, such as a schedule, a memo, contact data, and the like. This medium may be represented in the form of icon or thumbnail in a specific screen such as a message writing screen.

Although embodiments to be discussed hereinafter will be based on a message writing screen of a multimedia message service (MMS), this is exemplary only and not to be considered as a limitation of the present invention. Alternatively, this invention may be applied to any other specific screens of any other applications using media such as images, audios, videos, etc. For instance, this invention may be applied to an email writing screen to which media such as images, audios, videos, etc. may be selectively attached, and also may be applied to a picture frame composing screen of a picture frame application to display one or more images.

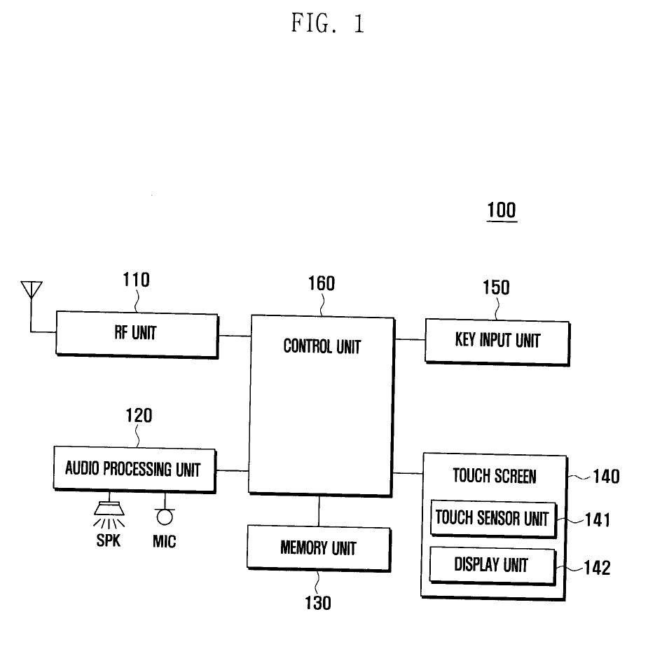

FIG. 1 is a block diagram illustrating the configuration of a mobile device in accordance with an exemplary embodiment of the present invention. Referring to FIG. 1, the mobile device 100 according to this embodiment includes a radio frequency (RF) unit 110, an audio processing unit 120, a memory unit 130, a touch screen unit 140, a key input unit 150, and a control unit 160.

The RF unit 110 performs a function to transmit and receive data for a wireless communication of the mobile device 100. Normally the RF unit 110 may include an RF transmitter that up-converts the frequency of an outgoing signal and then amplifies the signal, an RF receiver that amplifies with low-noise an incoming signal and down-converts the frequency of the signal, and the like. Additionally, the RF unit 110 may receive data through a wireless channel and then output it to the control unit 160, and also receive data from the control unit 160 and then transmit it through a wireless channel (not shown).

The audio processing unit 120 may include a codec, which may be composed of a data codec for processing packet data and an audio codec for processing an audio signal such as a voice. The audio processing unit 120 converts a digital audio signal into an analog audio signal through the audio codec and then outputs it through a speaker (SPK), and also convents an analog audio signal received from a microphone (MIC) into a digital audio signal through the audio codec.

The memory unit 130 stores programs and data required for operations of the mobile device 100 and may consist of a program region and a data region (not shown). The program region may store an operating system (OS) and programs for booting and operating the mobile device 100, applications required for the playback of multimedia contents, and applications required for the execution of various optional functions of the mobile device 100, such as a camera function, a sound reproduction function, an image or video playback function, and the like. The data region stores data created while the mobile device 100 is used, such as an image, a video, a phonebook, an audio, etc.

The touch screen unit 140 includes a touch sensor unit 141 and a display unit 142. The touch sensor unit 141 detects a user's touch input. The touch sensor unit 141 may be formed of touch detection sensors of capacitive overlay type, resistive overlay type or infrared beam type, or formed of pressure detection sensors. Alternatively, any other various sensors capable of detecting a contact or pressure of an object may be used for the touch sensor unit 141. The touch sensor unit 141 detects a user's touch input, creates a detection signal, and transmits the signal to the control unit 160. The detection signal contains coordinate data of a user's touch input. If a touch and moving gesture is inputted by a user, the touch sensor unit 141 creates a detection signal containing coordinate data about a moving path of touched point and then transmits it to the control unit 160. In embodiments of this invention, a touch and moving gesture may include a flick gesture that has a greater moving speed than a predefined critical speed, and a drag gesture that has a smaller moving speed than the predefined critical speed.

The display unit 142 may be formed of LCD (Liquid Crystal Display), OLED (Organic Light Emitting Diode), AMOLED (Active Matrix OLED), or any equivalent. The display unit 142 visually offers a menu, input data, function setting information and any other various information of the mobile device 100 to a user. The display unit 142 performs a function to output a booting screen, an idle screen, a menu screen, a call screen, or any other application screens of the mobile device 100. In embodiments of this invention, the display unit 142 displays a message writing screen that contains a media region and a text region. In this case, the display unit 142 displays a selected medium or media in the media region and also displays inputted text in the text region. Additionally, the display unit 142 modifies a GUI for at least one medium in the media region in response to a relevant touch input and also modifies text in the text region according to the GUI modification for media.

The key input unit 150 receives a user's key manipulation for the control of the mobile device 100, creates a corresponding input signal, and then delivers it to the control unit 160. The key input unit 150 may be formed of a keypad, having alphanumeric keys and navigation keys, disposed at the front side of the mobile device 100, and some function keys disposed at lateral sides of the mobile device 100. If the touch screen unit 140 is enough to manipulate the mobile device, the key input unit 150 may be omitted.

The control unit 160 (i.e., controller, processor, etc.) performs a function to control the whole operation of the mobile device 100. The control unit 160 according to an embodiment of this invention enters into a message writing menu in response to a user's command and then controls the display unit 142 to display a message writing screen that contains a media region for displaying at least one media, a text region for inputting text, and an attachment key. When detecting an input to select the attachment key through the touch sensor unit 141, the control unit 160 controls the display unit 142 to display a media list in which plural media are arranged. Also, the control unit 160 receives an input to select one of media in the media list from the touch sensor unit 141 and then controls the display unit 142 to dispose the selected media in the media region and to give a focus (e.g., a highlight, tag, bordering, brightening) to it. When detecting again an input to select the attachment key through the touch sensor unit 141, the control unit 160 controls the display unit 142 to display again the media list. Also, when receiving an input to select another media in the media list from the touch sensor unit 141, the control unit 160 controls the display unit 142 to further dispose the newly selected media in the media region and to give a focus (i.e., a highlight, tag) to it. Additionally, when receiving an input of text from the touch sensor unit 141, the control unit 160 controls the display unit 142 to display the text input in the text region and also correlates the text input with the focused media. Furthermore, when receiving a tap input on any media from the touch sensor unit 141, the control unit 160 controls the display unit 142 to give a focus to the tapped media and also correlates again the text input with the newly focused media.

Now, a method for offering a GUI of the mobile device 100 will be described in detail.

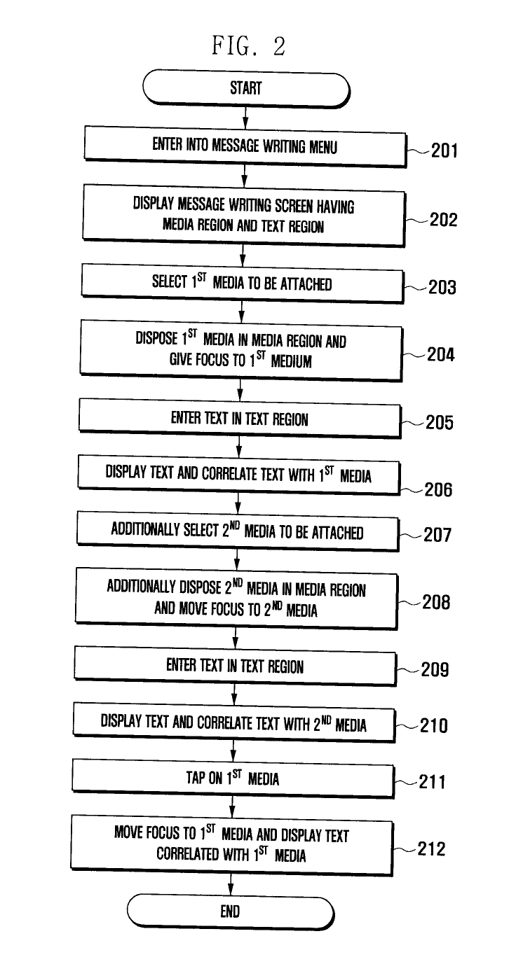

FIG. 2 is a flow diagram illustrating a method for offering a GUI of the mobile device in accordance with an exemplary embodiment of the present invention. The following description will be based on a message writing screen to which media to be sent are attached.

Referring to FIG. 2, in step 201, the control unit 160 enters into a message writing menu, as an example. Specifically, when a user selects a key for an entry into the message writing menu through the touch screen unit 140 or the key input unit 150, the control unit 160 receives an input signal from the touch screen unit 140 or the key input unit 150 and then enters (or executes) the message writing menu application. In this step, a user may input a command to enter into (execute) the message writing menu by selecting one of received messages in a message inbox, by selecting ‘a reply key’, or by selecting ‘a new message’ in a message menu. Namely, there are several methods and processes in which a message writing menu may be entered (i.e., the processing associated with the message writing menu is executed).

In step 202, the control unit 160 controls the display unit 142 to display a message writing screen that contains a media region for displaying at least one media region and a text region. The text region is for inputting text. The media region may contain one or more media disposed therein, and the locations or shapes of media may be varied according to a user's input. The text region is formed of a text input window. The text input window may be at a fixed position. Additionally, the control unit 160 further controls the display unit 142 to display an attachment key. The attachment key may be located in the media region or in the text region.

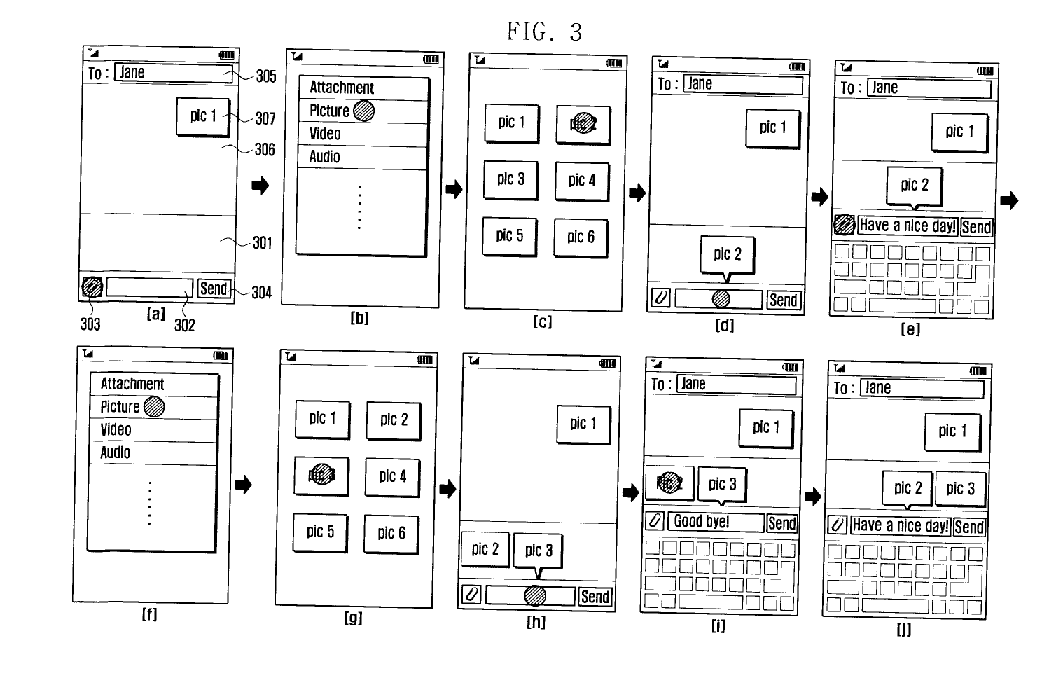

FIG. 3 shows a series of screenshots of a mobile device GUI offered by a method in accordance with an exemplary embodiment of the present invention.

Stage [a] of FIG. 3 shows the message writing screen. As shown in the stage [a] of FIG. 3, the message writing screen includes the media region 301, the text region 302, the attachment key 303, a send key 304, a recipient information region 305, a history region 306, and sent media 307. In another embodiment, the history region 306 and the sent media 307 may be omitted from the message writing screen. The message writing screen shown in stage [a] of FIG. 3 corresponds to a page for writing a reply message to ‘Jane’, for example. The sent media (pic 1) 307 disposed in the history region 306 indicates media that had already been sent to the recipient (“Jane’). In cases where a user selects ‘a new message’ in the message menu, the history region 306 may be expressed as an empty space and the sent media 307 is removed. If a user enters a recipient in the recipient information region 305, all the media sent to or received from the recipient may be disposed (illustrated) in the history region 306. In some embodiment, the media region 301 may be located under the text region 302.

Returning to FIG. 2, in step 203, the control unit 160 selects the first media to be attached. Specifically, when a user touches the attachment key, the control unit 160 controls the display unit 142 to display a list of media in which plural media stored in the memory unit 130 are arranged. The list of media may be displayed in the form of a pop-up window, for example. In another embodiment, when a user touches the attachment key, the control unit 160 may control the display unit 142 to display a media category list. If a user selects one media category in the media category list, the control unit 160 may control the display unit 142 to display the media list in which media belonging to the selected media category are arranged. In this disclosure, a term ‘media category’ refers to a particular group used to classify content or applications, such as a picture, a video, an audio, a contact, a calendar, a memo, a capture, etc.

When a user touches one of the elements (e.g., the first media element) in the media list, the control unit 160 receives an input to select the first element (media) listed on the media list from the touch sensor unit 141.

Stage [b] of FIG. 3 shows a screen offered when a user touches the attachment key 303 in stage [a] of FIG. 3. In this screen, a list of media categories including ‘picture’, ‘video’, ‘audio’, etc. is displayed in the form of a pop-up window. Stage [c] of FIG. 3 shows a screen offered when a user touches a media category ‘picture’ in the stage [b] of FIG. 3. In this screen, picture media such as ‘pic 1’, ‘pic 2’ and the like are arranged and, hence, form a list of media.

Returning to FIG. 2, in step 204, when an element is selected (e.g., a first media), the control unit 160 controls the display unit 142 to dispose the selected media in the media region 301 and to give a focus to the selected media. One or more media may be disposed in the media region, and a user who desires to enter text may select one of such media disposed in the media region.

In this disclosure, ‘a focus’ means a kind of GUI offered to distinguish a media selected by a user from the others. “Giving focus” to the selected media corresponds to displaying a focused media. In one embodiment, the focus may be formed by a prominent outline (e.g., highlighted border, different color border, larger border, etc.). In this case, the selected media is displayed with the prominent outline, whereas non-selected media are displayed without the prominent outline. In another embodiment, the non-selected media may be endowed with a dimming effect, while the focused media may be normally displayed or may even be more brightly displayed. In still another embodiment, a specific graphical element such as an arrow may be added to the selected media to illustrate that the selected media is in “focus.”

In some embodiment, if there is a single media in the media region 301, the control unit 160 may automatically select the existing media and control the display unit 142 to give a focus to it. Also, whenever another media is added to the media region, the control unit 160 may automatically select the latest media and control the display unit 142 to give a focus to it.

In some embodiment, when the first media is displayed, the control unit 160 may control the display unit 142 to put the first media at the center of the media region.

Stage [d] of FIG. 3 shows a screen offered when a user selects a picture media ‘pic 2’ in the media list shown in the stage [c] of FIG. 3. As shown in the stage [d] of FIG. 3, the selected media ‘pic 2’ is displayed in the media region 301. Particularly, the selected media ‘pic 2’ is located at the center of the media region 301 in the form of a thumbnail. Also, an arrow-like element that points the text region 302 is added to this media ‘pic 2’.

Returning to FIG. 2, in step 205, the control unit 160 detects that a text input is desired. For example, the control unit 160 may sense a tap on the text region 302. In this case, the control unit 160 controls the display unit 142 to display a keypad and receives a text input from the touch sensor unit 141, when a user enters text through a touch gesture on the keypad. In another embodiment, the control unit 160 may control the display unit 142 to display the keypad when a user touches the text region, and then may control the display unit 142 to remove the keypad when a user selects a text input completion key or inputs a command to select other media in the media region.

In step 206, the control unit 160 controls the display unit 142 to display the text input and also correlates the text input with the focused first media. Specifically, the control unit 160 controls the display unit 142 to display text in the text region in response to a user's keypad input, correlates the text input with the first media, and temporarily stores it in the memory unit 130. In another embodiment, after controlling the display unit 142 to display text in the text region in response to a user's keypad input, the control unit 160 may correlate the text input with the first media and temporarily store it in the memory unit 130 when receiving an input of selecting the attachment key, the send key, or other media in the media region from the touch sensor unit 141.

Stage [e] of FIG. 3 shows a screen offered when a user touches the text region 302 in the stage [d] of FIG. 3. As shown in the stage [e] of FIG. 3, the keypad appears by means of a touch on the text region 302, and a user enters desired text, for example, ‘Have a nice day!’ in the text region 302 through the keypad. Since the selected media ‘pic 2’ is focused in the media region 301, the control unit 160 correlates a text input ‘Have a nice day!’ in the text region 302 with the focused media ‘pic 2’. Also, stage [e] of FIG. 3 shows a touch on the attachment key 303. In some embodiment, when receiving a touch input on the attachment key 303 from the touch sensor unit 141, the control unit 160 may correlate the text input ‘Have a nice day!’ with the focused media ‘pic 2’ and then temporarily stores it (i.e., the text and a correlation indication) in the memory unit 130.

In step 207, the control unit 160 further selects the second media to be attached. Similar to the above-discussed step 203, when a user touches the attachment key, the control unit 160 controls the display unit 142 to display a media category list. Then the control unit 160 may control the display unit 142 to display a list of media belonging to the selected media category when a user selects one media category in the media category list. If a user touches one of media in the media list (i.e., a second media), the control unit 160 receives an input to select the touched media (i.e., second media) from the touch sensor unit 141.

Stage [f] of FIG. 3 shows a screen offered when a user touches the attachment key 303 in the stage [e] of FIG. 3. In this screen, the media category list is displayed. The stage [f] of FIG. 3 corresponds to the above-discussed stage [b] of FIG. 3. Stage [g] of FIG. 3 shows a screen that is displayed when a user touches a media category ‘picture’ in the stage [f] of FIG. 3. In this screen, the media list is displayed. The stage [g] of FIG. 3 corresponds to the above-discussed stage [c] of FIG. 3 and further shows that a user selects a picture media ‘pic 3’ as the second media. Note that pic 2 in [g] has been already selected.

After the second media is selected (i.e., pic 3), in step 208, the control unit 160 controls the display unit 142 to further dispose the selected second media in the media region and to move the focus to the second media. Therefore, the media region 301 contains the first and second selected media (e.g., pic 2 and pic 3). Focus is automatically applied to the next media when the selected media is added, one by one, to the media region 301. In another embodiment, the control unit 160 may control the display unit 142 to retain the focus at the first selected media, even though a next media (e.g., pic 3) is added to the media region 301.

In some embodiment, the control unit 160 may control the display unit 142 to dispose the second selected media to another space in the media region 301 without moving the first selected media and also to move the focus from the first selected media to the second selected media. Alternatively, the control unit 160 may control the display unit 142 to move the first selected media and then dispose the second select media in the media region 301. For instance, the control unit 160 may control the display unit 142 to move the first media, which is located at the center of the media region 301, leftward or rightward and then put the second selected media at the center of the media region 301.

Additionally, in another embodiment, the control unit 160 may control the display unit 142 to fix the location of the focus and move the media selected into the fixed location in order to indicate which of the selected media is focused. For instance, while the focus is fixed at the center of the media region 301, the control unit 160 may control the display unit 142 to move the selected media in order to change (replace) the media located at the center of the media region.

Stage [h] of FIG. 3 shows a screen offered when a user selects a picture media ‘pic 3’ in the media list shown in the stage [g] of FIG. 3. As shown in stage [h] of FIG. 3, the media ‘pic 2’ and ‘pic 3’ are displayed in the media region 301. Particularly, the currently selected media ‘pic 3’ is located at the center of the media region 301 and the previously selected media ‘pic 2’ is moved leftward. The focus is placed onto ‘pic 3’, and ‘pic 2’ is endowed with a dimming effect, for example. Also, an arrow-like element added to ‘pic 2’ in the stage [d] of FIG. 3 is removed, and the arrow-like element is applied to ‘pic 3’.

Returning to FIG. 2, in step 209, the control unit 160 detects another text input. Specifically, the control unit 160 controls the display unit 142 to display the keypad and, when a user enters text through a touch gesture on the keypad, the control unit 160 receives a text input from the touch sensor unit 141.

In step 210, the control unit 160 controls the display unit 142 to display the text input and also correlates the text input with the selected media (e.g., pic 3). Specifically, the control unit 160 controls the display unit 142 to display text in the text region in response to a user's keypad input, correlates the text input with the third media, and temporarily stores it in the memory unit 130.

Stage [i] of FIG. 3 shows a screen offered when a user touches the text region 302 in the stage [h] of FIG. 3. As shown in the stage [i] of FIG. 3, the keypad appears by means of a touch on the text region 302, and a user enters desired text, for example, ‘Good bye!’ in the text region 302 through the keypad. Since the currently selected media ‘pic 3’ is focused, the control unit 160 correlates or associates the text input ‘Good bye!’ in the text region 302 with the focused media ‘pic 3’.

In step 211, the control unit 160 receives a tap input on another media. That is, the user selects a non-focused media by tapping on the media. If a user taps the first media while the focus is associated with to a focused media (e.g., pic 3), the control unit 160 operates to transfer the focus to the selected non-focused media.

In step 212, the control unit 160 controls the display unit 142 to move the focus to the tapped media and also displays any text correlated to, or associated with, the now focused media in the text region. The tapped (selected) media and the focus are also moved in the media region 301. However, in the text region, text input window is fixed and only the text input window content are changed. Thus, if the focus is moved to the first media (e.g., pic 2), the control unit 160 controls the display unit 142 to replace the current text (correlated with the pic 3 media) with the text correlated with the pic 2 media.

Stage [j] of FIG. 3 shows a screen offered when a user touches the non-focused media ‘pic 2’ in the stage [i] of FIG. 3. As shown in stage [j] of FIG. 3, ‘pic 2’ is moved to the center of the media region 301. A dimming effect is removed from ‘pic 2’, and the focus is applied to the now selected ‘pic 2’. Also, in the text region 302, text ‘Good bye!’ correlated with ‘pic 3’ is replaced with the text ‘Have a nice day!,’ which is associated with or correlated to the now focused ‘pic 2’.

According to another embodiment, in the step 211, the control unit 160 may determine whether a touch and moving gesture is inputted in the media region 301, instead of determining whether there is a tap input on the non-focused media. Here, the touch and moving gesture may be a flick gesture that has a smaller moving distance than a predefined critical distance and has a greater moving speed than a predefined critical speed. In this case, the control unit 160 may control the display unit 142 to move at least one media or the focus in the media region, depending on touch moving direction, distance and speed. For instance, if a user touches any spot in the media region 301 and then takes a rightward flick gesture as shown in stage [i] of FIG. 3, the media ‘pic 2’ and ‘pic 3’ are moved rightward and the focus is moved from ‘pic 3’ to ‘pic 2’ as shown in stage [j] of FIG. 3.

Although the method shown in FIG. 2 is based on two media (i.e., a first media and a second media), this is exemplary only and not to be considered as a limitation of the present invention. Alternatively, this invention may be applied to other cases in which three or more media are selected as attachment files. In these cases, the steps 203 to 206 or the steps 207 to 210 are repeatedly performed after the step 210 so as to sequentially select the third media, the fourth media, and an n^{th} media.

Additionally, although the method shown in FIG. 2 performs the step of entering text just after the step of selecting a single media, this is exemplary only and not to be considered as a limitation of the present invention. In the method according to an alternative embodiment, several media may be selected and then a text input process may be performed for the respective media. In this case, the steps 203 and 204 are repeated and then, depending on a tap input or touch and moving input in the media region, the next steps 205 and 206 are performed.

Furthermore, although the method shown in FIG. 2 selects the media, one by one, this is merely exemplary and should not to be considered as a limitation of, or the only method of operation of, the present invention. Alternatively, two or more media may be selected at a time from the media list. In this case, the control unit 160 receives an input to select the media from the touch sensor unit 141 in the step 203, and then controls the display unit 142 to dispose the selected media in the media region in the step 204. The media may be arranged according to user's selection order. Also, the focus may be given to the initially selected media or the finally selected media.

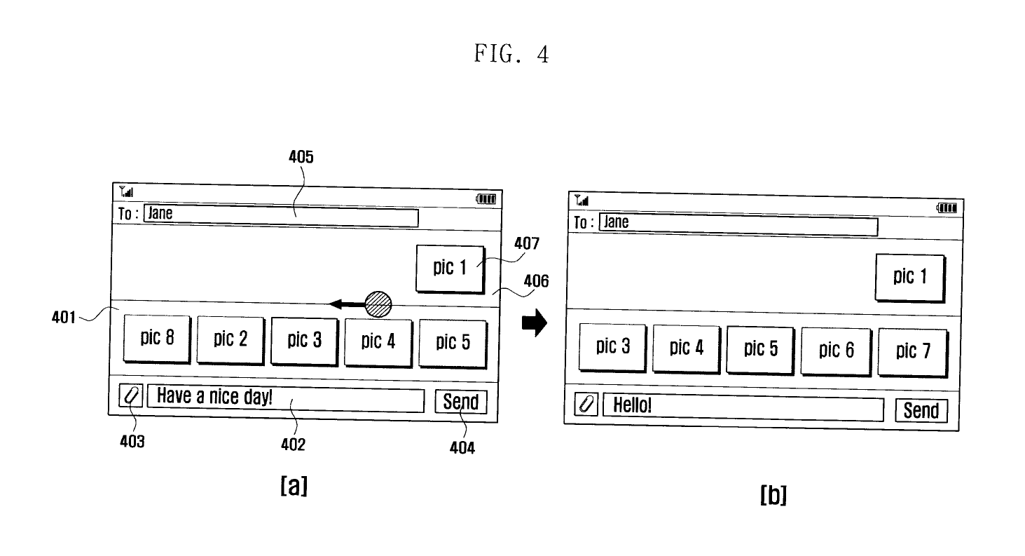

FIG. 4 shows screenshots of a mobile device GUI offered by a method in accordance with another exemplary embodiment of the present invention.

Stage [a] of FIG. 4 shows the message writing screen when the mobile device 100 is in the landscape mode (i.e., the widthwise mode). As shown in stage [a] of FIG. 4, the message writing screen includes a media region 401, a text region 402, an attachment key 403, a send key 404, a recipient information region 405, a history region 406, and sent media 407. When the mobile device 100 is in the landscape mode in which its longer side is a horizontal side, the number of media displayable in the media region 401 may increase. For instance, the media region 401 shown in the stage [a] of FIG. 4 contains five media ‘pic 2’, ‘pic 3’, ‘pic 4’, ‘pic 5’ and ‘pic 8’. Media ‘pic 3’ is the object of the focus, in this exemplary illustration. Also, shown in stage [a] of FIG. 4 is the user touching a point in the media region 401 (as indicated by the hashed circle) and then moves the touch point leftward (as indicated by the arrow direction).

Stage [b] of FIG. 4 shows a screen offered when a user touches a point in the media region 401 and then moves leftward the touch point as discussed with regard to stage [a] of FIG. 4. As shown in stage [b] of FIG. 4, the displayed media are moved two spaces leftward in the media region 401, so the rightmost media ‘pic 5’ in the stage [a] of FIG. 4 is moved to the center of the media region 401. Also, the focused media ‘pic 3’ in the stage [a] of FIG. 4 is moved to the leftmost position in the media region 401, and the focus is applied to ‘pic 5’. Two media ‘pic 8’ and ‘pic 2’ in the stage [a] of FIG. 4 are removed from view, and two addition media ‘pic 6’ and ‘pic 7’ are displayed. In the particular embodiment shown in FIG. 4, the focus is fixed at the center of the media region 401, and any centered media is focused in the media region 401. However, it may be recognized that the focus may remain with the shifted media and that the user may be required to tap an unselected media to select the unselected media. The focus is then moved to the tapped (i.e., now selected) media.

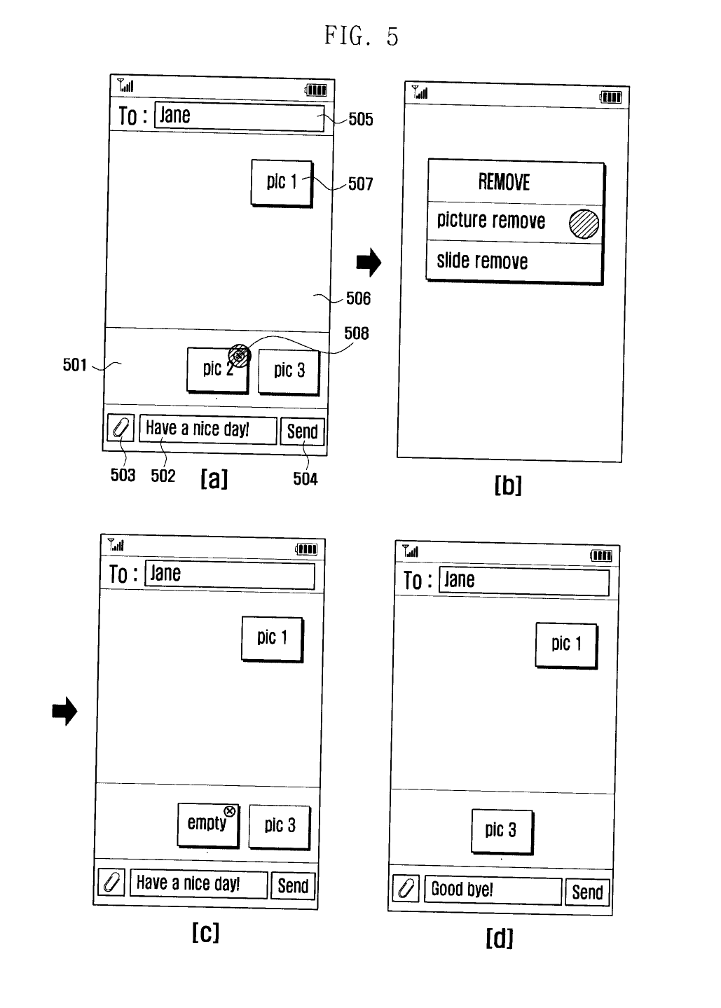

FIG. 5 shows screenshots illustrating a function to remove a media in a message writing screen of a mobile device.

Referring to FIG. 5, ‘a removal key’ may be added to the media in the media region 501. The removal key may appear with the focused media only or in all the media disposed in the media region 501. The message writing screen shown in stage [a] of FIG. 5 includes a media region 501, a text region 502, an attachment key 503, a send key 504, a recipient information region 505, a history region 506, sent media 507, and a varying removal key 508. In the media region 501, ‘pic 2’ is the focused media and has the removal key 508.

When a user selects the removal key 508, the control unit 160 may control the display unit 142 to display a pop-up window for selecting one of a media removal and a list removal. In this disclosure, ‘a media removal’ means the act of removing only the media content while still maintaining the media frame in which the media content is displayed on the media region. Also, ‘a list removal’ means the act of removing the media itself from the media region. The stage [a] of FIG. 5 shows that a user touches the removal key 508 added to ‘pic 2’, and a stage [b] of FIG. 5 shows the pop-up window floated in response to a user's touch on the removal key 508. This pop-up window contains items ‘picture remove’ corresponding to the media removal and ‘slide remove’ corresponding to the list removal.

If a user selects the media removal, the control unit 160 controls the display unit 142 to remove only the content of the elected media while leaving the media frame. Therefore, the selected media may be displayed as an empty image. In some embodiments, the removal key may be still displayed on the empty image until a user again selects the removal key. Meanwhile, when the selected medium is displayed as an empty image, the control unit 160 may control the display unit 142 to maintain the text in the text region. That is, even though the content of selected media is removed, the text correlated with the selected media remains displayed.

Stage [c] of FIG. 5 shows a screen offered when a user selects the item ‘picture remove’ corresponding to the media removal in the stage [b] of FIG. 5. As shown in the stage [c] of FIG. 5, the selected medium ‘pic 2’ is changed to the empty image, whereas the text ‘Have a nice day!’ in the text region 502 is still maintained.

If a user selects the attachment key under the condition that the media is displayed as the empty image, the control unit 160 may control the display unit 142 to display the media list and then fill the empty image with another media selected by a user from the media list.

If the user selects the list removal between the media removal and the list removal, the control unit 160 may control the display unit 142 to remove the selected media from the media region and also remove the text from the text region. Therefore, the media region comes to contain the remaining media other than the removed media, and the text region becomes blank. In some embodiments, the control unit 160 may control the display unit 142 to apply the focus to another media in the media region and also display text correlated with the focused media in the text region. Stage [d] of FIG. 5 shows a screen offered when a user selects the item ‘slide remove’ corresponding to the list removal in stage [b] of FIG. 5. As shown in the stage [d] of FIG. 5, the selected medium ‘pic 2’ is completely removed from the media region 501 and the remaining media ‘pic 3’ is displayed in the media region 501. According as ‘pic 2’ is removed, ‘pic 3’ is moved to the center of the media region 501 and the focus is applied to the remaining ‘pic 3.’ Also, the text ‘Good bye!’ correlated with the newly focused media ‘pic 3’ is displayed in the text region 502.

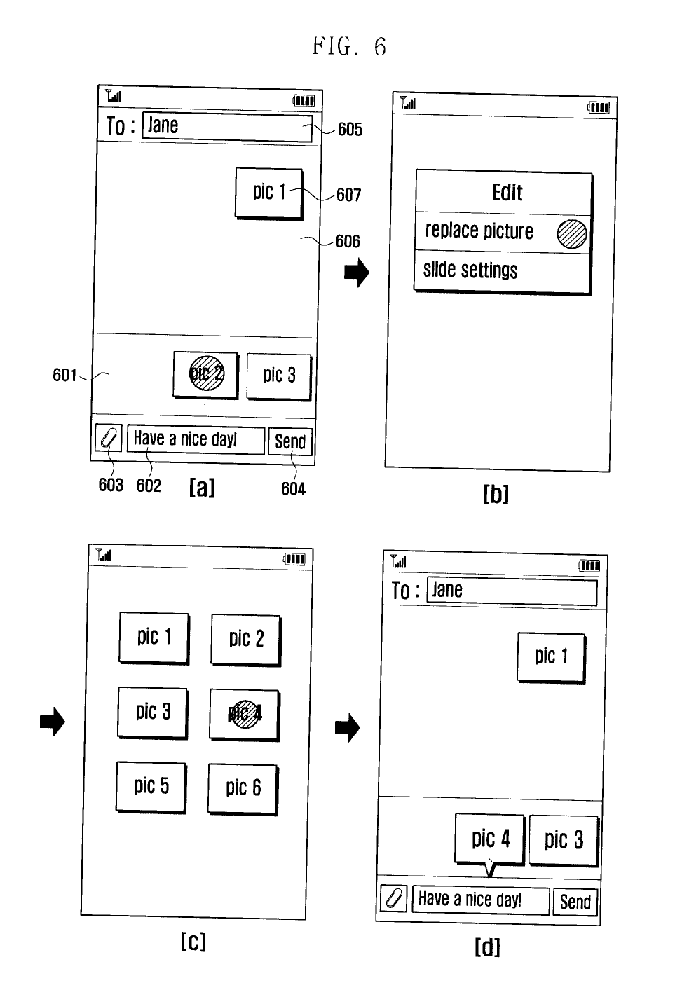

FIG. 6 shows screenshots illustrating a function to replace a media in a message writing screen of a mobile device.

In this illustrated example, if there is a tap input or a long tap input (i.e., a tap input more than a known time) on the selected media in the media region 601, the control unit 160 may control the display unit 142 to display a pop-up window for a media replacement. Also, in some embodiments, the control unit 160 may control the display unit 142 to additionally display (not shown) a menu for a media playback setting (e.g., slide time setting, etc.). The message writing screen shown in a stage [a] of FIG. 6 includes a media region 601, a text region 602, an attachment key 603, a send key 604, a recipient information region 605, a history region 606, and sent media 607. Stage [a] of FIG. 6 shows that a user makes a tap gesture (as indicted by the hashed circle) on the selected media ‘pic 2’, and stage [b] of FIG. 6 shows the pop-up window floated in response to a user's tap on the selected media ‘pic 2.’ The pop-up window may contain the item ‘replace picture’, in addition to the item ‘slide setting’ corresponding to the media replacement indication.

If a user selects the media replacement (i.e., replace picture as indicated by the hashed circle), the control unit 160 controls the display unit 142 to display the media list. Stage [c] of FIG. 6 shows the media list containing several media. Stage [c] of FIG. 6 also shows that the user has selected ‘pic 4’ (as indicated by the hashed circle).

When a user selects one of the media (e.g., pic 4), the control unit 160 controls the display unit 142 to replace the tapped media with the selected media (i.e., replace pic 2 with pic 4). In this case, the control unit 160 controls the display unit 142 to maintain the text in the text region. Therefore, this case may be used when a user desires to change the media and not the associated text. By comparison with stage [b] of FIG. 6, in stage [d] of FIG. 6, ‘pic 2’ is replaced with ‘pic 4’, and the text ‘Have a nice day!’ in the text region is unchanged. By the media replacement, the text ‘Have a nice day!’ correlated with ‘pic 2’ is now correlated with the replacement media ‘pic 4’.

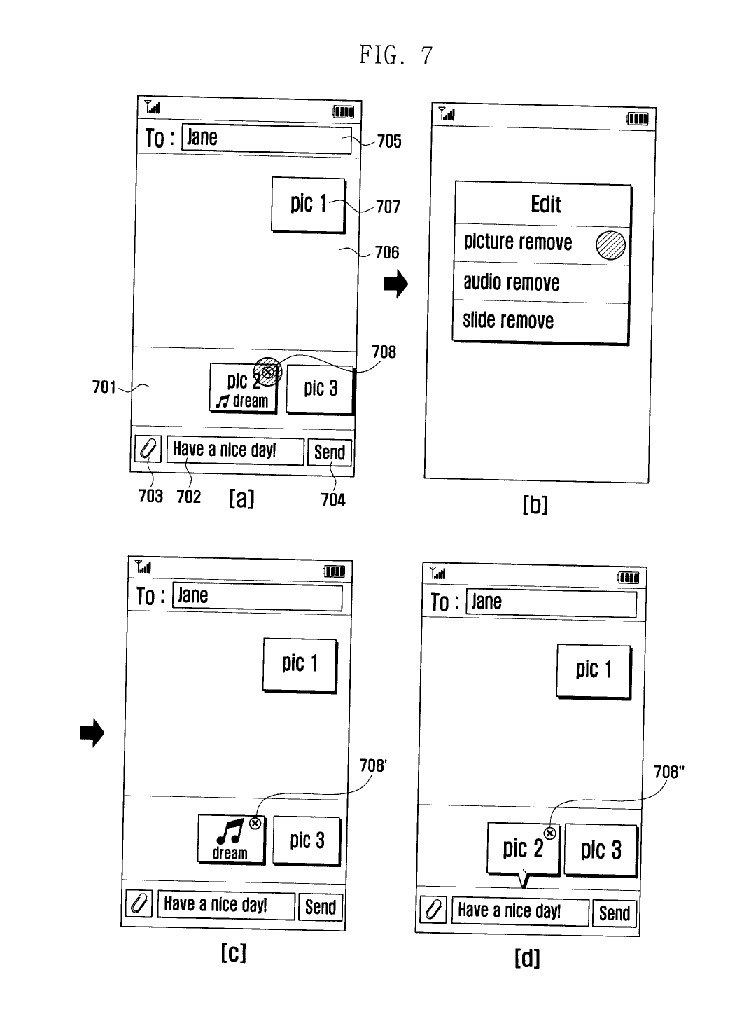

FIG. 7 shows screenshots illustrating a function to remove a plurality of media in a message writing screen of a mobile device.

In this case, any media disposed in the media region may represent a combination of two or more media. For instance, a picture file and an audio file may be combined and then displayed as a single media in the media region. Also, as discussed above, the removal key may be added to the media. The message writing screen shown in stage [a] of FIG. 7 includes a media region 701, a text region 702, an attachment key 703, a send key 704, a recipient information region 705, a history region 706, sent media 707, and the removal key 708, that may be applied to the focused media. As shown in stage [a] of FIG. 7, the media region 701 may contain a single combination media into which a picture file ‘pic 2’ and an audio file ‘dream’ are combined. This combination media is focused and the removal key 708 is applied to this combination media.

When a user selects the removal key 708, the control unit 160 may control the display unit 142 to display a pop-up window (stage [b] of FIG. 7) for selecting one of the media removal and the list removal. Additionally, the control unit 160 may control the display unit 142 to display a pop-up window for selectively removing each individual media constituting the combination media. For instance, if the combination media is composed of a picture file and an audio file, the control unit 160 may control the display unit 142 to display a pop-up window that contains a picture remove, an audio remove and a slide remove. (stage [b] of FIG. 7). The stage [a] of FIG. 7 shows that a user touches the removal key added to the combination medium of ‘pic 2’ and ‘dream’ (as indicated by the hashed circle), and stage [b] of FIG. 7 shows the pop-up window floated in response to a user's touch on the removal key 708. In this illustrated case, the pop-up window is composed of three items, the picture remove, the audio remove and the slide remove.

In this case, if a user selects the picture remove item, the control unit 160 controls the display unit 142 to display only an audio file image of the selected media while maintaining the media frame. In some embodiments, the control unit 160 may control the display unit 142 to leave the removal key 708′ in the audio file image even after the selected media (pic 2) is removed and only the audio file image is retained. Then, if a user selects again the removal key 708′, the control unit 160 may control the display unit 142 to remove the audio file image from the media region 701. At this time, the control unit 160 controls the display unit 142 to keep any associated text displayed in the text region. Namely, the text correlated with the selected combination media is not removed even though the corresponding picture file and/or audio file is removed.

A stage [c] of FIG. 7 shows a screen offered when a user selects the item ‘picture remove’ corresponding to a picture file removal in stage [b] of FIG. 7. As shown in stage [c] of FIG. 7, the selected picture file ‘pic 2’ is removed, and thereby the combination media is displayed as an audio file image. Meanwhile, the text ‘Have a nice day!,’ which is associated with the picture file ‘pic 2’ is retained in the text region 702.

If a user selects the audio remove item in the pop-up window, the control unit 160 controls the display unit 142 to remove an audio file image and then display only a picture file image of the selected media. In some embodiment, the control unit 160 may control the display unit 142 to leave the removal key 708″ in the picture file image of the selected media. Then, if a user again selects the removal key 708″, the control unit 160 may control the display unit 142 to remove the picture file image from the media region. Also, the control unit 160 controls the display unit 142 to retain the text (which is associated with pic 2) displayed in the text region.

Stage [d] of FIG. 7 shows a screen offered when a user selects the item ‘audio remove’ in the stage [b] of FIG. 7. As shown in the stage [d] of FIG. 7, the audio file image is removed, and, thus, the combination media is displayed as the picture file ‘pic 2’ only. The text ‘Have a nice day!’ in the text region 702 is retained.

If a user selects the slide remove item in the pop-up window, the control unit 160 may control the display unit 142 to remove the selected media from the media region and also remove the text from the text region. Therefore, the media region contains only the remaining media, and the text region becomes blank. In some embodiments, the control unit 160 may control the display unit 142 to apply the focus to a remaining media in the media region and also display text correlated with the now focused medium in the text region.

As fully discussed hereinbefore, in case of writing a message using several media, the GUI of this invention not only allows checking, in a single screen, which media is selected and what text is correlated with each medium, but also allows a simpler and easier method for editing the message containing the media and associated text.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for offering a graphic user interface (GUI) of a mobile device including a control unit, the method operable in the processing unit, wherein the control unit executes the steps of:
displaying a GUI screen containing a media region and a text region, the media region being provided for displaying at least one media;
correlating text input to the text region with one of the at least one media; and
modifying the GUI of the at least one media when there is a touch on the media region.

2. The method of claim 1, wherein displaying the GUI screen includes:
displaying regions, wherein the regions have the media region in which the at least one media is disposed, and the text region in which the text is inputted; and
displaying media, wherein the displaying of the media includes disposing the at least one media in the media region in response to a user's media selection, and applying a focus to the disposed media.

3. The method of claim 2, wherein correlating of the text includes:
when the text is inputted in the text region, displaying the inputted text and then correlating the text with the focused medium.

4. The method of claim 3, wherein modifying the GUI includes:
focusing another one of the at least one media in response to the touch when there is the touch on the media region.

5. The method of claim 4, wherein modifying the GUI further includes replacing the text in the text region with another text correlated with the focused another one of the at least one media.

6. The method of claim 2, wherein displaying the regions further includes displaying a media attachment key.

7. The method of claim 6, wherein the displaying the media includes:
displaying a media list containing a plurality of media when the media attachment key is selected;
disposing the first medium in the media region when a first media is selected in the media list; and
applying a focus to the selected first medium.

8. The method of claim 7, wherein displaying the media further includes:
displaying again the media list when the media attachment key is selected after the first media is disposed in the media region;
additionally disposing a second media in the media region when the second media is selected from the media list; and
applying a focus to the selected second media.

9. The method of claim 2, wherein modifying the GUI further includes:
determining whether a tap gesture is inputted on a non-focused media in the media region; and
moving the focus to the tapped medium if the tap gesture is inputted.

10. The method of claim 2, wherein modifying the GUI further includes:
determining whether a touch and moving gesture is inputted in the media region; and
moving the focus to another media depending on touch moving direction, distance or speed if the touch and moving gesture is inputted.

11. The method of claim 2, wherein modifying the GUI further includes:
moving the at least one media while retaining the focus at a fixed location.

12. The method of claim 2, wherein displaying the media further includes:
adding a dimming effect to at least one media other than the focused medium.

13. The method of claim 2, wherein displaying the media further includes:
adding a removal key to at least one of the media.

14. The method of claim 13, further comprising:
displaying a pop-up window for selecting one of a media removal and a list removal when the removal key is selected;
changing the media related to the removal key to an empty image while retaining the text associated with the selected media in the text region when the media removal is selected; and
when the list removal is selected, removing the media, and any associated text, related to the removal key from the media region and the text region, respectively.

15. The method of claim 1, further comprising:
displaying a pop-up window for a media replacement when a touch gesture is inputted on one of the at least one media;
displaying a media list containing a plurality of media when the media replacement is selected; and
replacing the touched media with another media selected from the media list.

16. A mobile device comprising:
a touch sensor unit configured to detect a user's touch input;
a display unit configured to display a media region in which at least one media is disposed, and to display a text region in which text is inputted; and
a control unit to:
dispose and focus the at least one media in the media region on the display unit to in response to a user's media selection received from the touch sensor unit,
display the text in the text region on the display unit in response to a user's text input received from the touch sensor unit, and
correlate the text with the focused medium, and
change the focus to another media in response to a touch input on the another media in the media region received from the touch sensor unit.

17. The mobile device of claim 16, wherein the control unit is further configured to control the display unit to replace the text in the text region with another text correlated with the focused another media.

18. A mobile terminal comprising:
a display unit;
a input unit; and
a control unit in communication with a memory, the memory including code, which when accessed by the control unit causes the control unit to execute the steps of:
presenting GUI including a media region and a text region on the display unit;
presenting at least one media in the GUI, the at least one media comprising at least one of a picture file and an audio file,
selecting at least one of the presented at least one media in response to an input on said input unit;
displaying the selected at least one of the presented at least one media in the media region;
applying a focus to one of the at least one selected at least one media,
receiving, in the text region, a text input from the input unit; and
associating the text input to the focused media.

19. The mobile terminal of claim 18, wherein the processor further executing applying a removing key to at least one of the media presented in the media region.

20. The mobile terminal of claim 19, wherein the control unit further executes the steps of:
removing a least one media in response to an activation of the removal key; and
retaining the text associated with the removed at least one media.
